(19) United States
(12) Patent Application Publication
(10) Pub. No.: US 2010/0148670 A1
(43) Pub. Date: Jun. 17, 2010

(54) ELECTRON SOURCE SUBSTRATE AND IMAGE DISPLAY APPARATUS

(75) Inventors: Kenichi Nakamura, Hiratsuka-shi (JP); Yukihiro Inoue, Ebina-shi (JP); Koji Yamazaki, Ayase-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/632,971

(22) Filed: Dec. 8, 2009

(30) Foreign Application Priority Data
Dec. 11, 2008 (JP) 2008-315444

(51) Int. Cl. H01J 7/44

(52) U.S. Cl. 315/71

(57) ABSTRACT

Row-directional wires, column-directional wires having a resistance higher than that of the row-directional wires, and electron-emitting devices are disposed on a substrate. The electron-emitting devices and the column-directional wires are each connected via a resistor element. The resistor element is provided with a local fuse portion that is easier to fuse than the other portion. The fuse portion is provided closer to the row-directional wire than to the column-directional wire.

### BACKGROUND OF THE INVENTION

1. Field of the Invention

The present invention relates to an electron source substrate in which a plurality of electron-emitting devices are disposed in matrix form, as well as an image display apparatus incorporating the same.

2. Description of the Related Art

A known example of application of electron-emitting devices is an image display apparatus. For example, a known flat electron-beam display panel in the related art is configured such that an electron source substrate including a plurality of cold-cathode electron-emitting devices and a counter substrate including an anode electrode that accelerates electrons emitted from the electron-emitting devices and a fluorescent member serving as a light-emitting member are opposed in parallel. The flat electron-beam display panel can be made more lightweight and larger in size than cathode-ray tube (CRT) displays that are now in general use. Moreover, the flat electron-beam display panel can provide higher-brightness and higher-quality images than other flat display panels, such as flat liquid-crystal display panels, plasma displays, and electroluminescent displays.

To accelerate electrons emitted from the cold-cathode electron-emitting devices, it is preferable for the type of image display apparatus in which voltage is applied between the anode electrode and the devices that high voltage is applied to obtain the maximum brightness. Depending on the type of devices, emitted electron beams are diverged before reaching the anode electrode. Therefore, to achieve a high-resolution display, it is preferable to intensify the electric field between the rear plate and the face plate.

However, the high-intensity electric field between the substrates is prone to cause a phenomenon in which the electron-emitting devices are broken due to discharge. Japanese Patent Laid-Open No. 2003-157757 (equivalent to US Patent Application 2003/0,062,843) discloses a technology for reducing damages on electron-emitting devices during discharge by connecting resistor elements between the electron-emitting devices and wires. Japanese Patent Laid-Open No. 2007-87934 (equivalent to EP A2 1,758,146) discloses a technology for reducing damages on electron-emitting devices during discharge by providing easily fused regions between the electron-emitting devices and wires.

However, the configurations disclosed in Japanese Patent Laid-Open Nos. 2003-157757 and 2007-87934 require an electron source substrate and an image display apparatus that have more reliable performance against discharge.

### SUMMARY OF THE INVENTION

The invention provides an electron source substrate in which electron-emitting devices other than electron-emitting devices into which discharge is induced and driving circuits are not influenced by the discharge, and an image display apparatus incorporating the electron source substrate.

According to a first aspect of the invention, there is provided an electron source substrate including a substrate; a row-directional wire disposed on the substrate; a column-directional wire disposed on the substrate; an electron-emitting device a first end of which is connected to the row-directional wire and a second end of which is connected to the column-directional wire via a resistor element, and to which operating voltage is applied through the row-directional wire and the column-directional wire, wherein the resistance of the row-directional wire is lower than the resistance of the column-directional wire; and wherein the resistor element includes a local fuse portion that is easier to fuse than the other portion, the fuse portion being disposed closer to the row-directional wire than to the column-directional wire.

In the electron source substrate according to the first aspect, it is preferable that the fuse portion be a current-concentration portion into which electrical current is to be concentrated; the current-concentration portion be a bent portion; the current-concentration portion be smaller in cross-sectional area than the other portion; part of the row-directional wire have a current absorbing portion protruding toward the fuse portion; the row-directional wire be covered with an insulator; and the column-directional wire be covered with an insulator.

According to a second aspect of the invention, there is provided an image display apparatus incorporating an electron source substrate including a plurality of electron-emitting devices and wires through which voltage is applied to the electron-emitting devices; and a light-emitting substrate including a fluorescent layer that emits light by irradiation with electrons emitted from the electron-emitting devices, wherein the electron source substrate is the electron source substrate according to claim 1.

In the image display apparatus according to the second aspect, it is preferable that electrons be emitted to one pixel from two or more electron-emitting devices.

According to an embodiment of the invention, because the fuse portion of the resistor element connected to the electron-emitting device is fused during discharge, an electric current to the column-directional wire is interrupted, and secondary discharge induced by the discharge is led to the row-directional wire close to the fuse portion. Since the row-directional wire has a resistance lower than that of the column-directional wire, an increase in the potential of the column-directional wire can be prevented even if high current due to the discharge flows therethrough. This prevents the destruction of surrounding electron-emitting devices and driving circuits, thus providing an electron source substrate and an image display apparatus with high reliability.

Further features of the invention will become apparent from the following description of exemplary embodiments (with reference to the attached drawings).

### BRIEF DESCRIPTION OF THE DRAWINGS

FIG. 1 is a schematic plan view of part of an electron source substrate according to an embodiment of the invention.

FIG. 2 is a schematic cross-sectional view of the electron source substrate in FIG. 1.

FIG. 3 is a schematic plan view of part of an electron source substrate according to another embodiment of the invention.

FIG. 4 is a schematic perspective view showing the configuration of a display panel of an image display apparatus according to an embodiment of the invention.

FIG. 5 is a schematic fragmentary cross-sectional view of the display panel shown in FIG. 4.

FIG. 6 is a schematic plan view of part of an electron source substrate according to another embodiment of the invention.

FIG. 7 is a schematic cross-sectional view taken along line VII-VII in FIG. 6.

FIG. 8 is a schematic plan view of part of an electron source substrate according to another embodiment of the invention.

### DESCRIPTION OF THE EMBODIMENTS

Embodiments of the invention will be described hereinbelow.

Examples of electron-emitting devices that constitute an electron source substrate according to an embodiment of the invention include a surface-conduction electron-emitting device, a field emission device, and a metal-insulator-metal (MIM) device. In particular, the surface-conduction electron-emitting device is desirable for application of the invention because anode and cathode regions are disposed in plane.

First, an electron source substrate according to an embodiment of the invention will be specifically described with reference to the drawings. In this embodiment, a configuration in which a surface-conduction electron-emitting device is used as an electron-emitting device is shown.

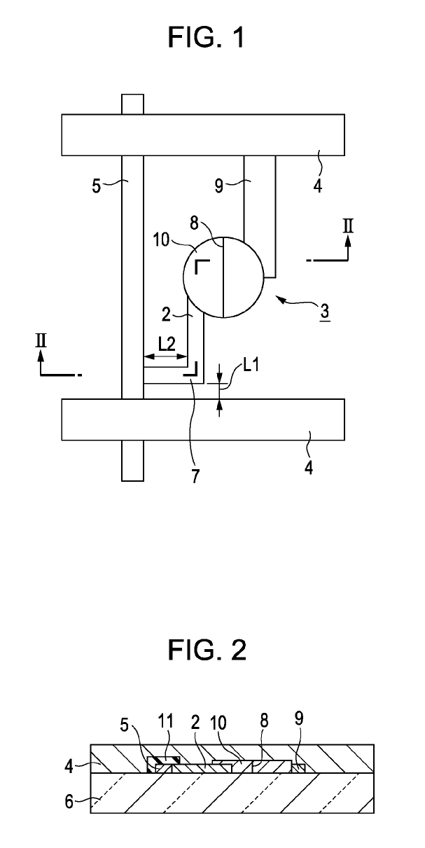

FIG. 1 is an enlarged schematic plan view of an electron-emitting device of the electron source substrate according to the embodiment of the invention. FIG. 2 is a schematic cross-sectional view taken along line II-II in FIG. 1.

The electron source substrate according to the embodiment of the invention has row-directional wires 4, column-directional wires 5, and electron-emitting devices on a substrate 6. In this embodiment, the resistance of the row-directional wires 4 is lower than the resistance of the column-directional wires 5. The resistances of the row-directional wires 4 and the column-directional wires 5 are changed as appropriate, depending on the characteristics of the electron-emitting devices, the size of the matrix and so on. For example, for a wide display, the resistance of the column-directional wires 5 is five times or more that of the row-directional wires 4 because of a space to be occupied.

In general, the surface-conduction electron-emitting device includes a pair of device electrodes and a conductive film between the device electrodes, and the conductive film has an electron emitting portion. According to this embodiment, one end of each electron-emitting device is connected to each of the row-directional wires 4, and the other end is connected to each of the column-directional wires 5 via a resistor element 2. This embodiment is configured such that the device electrode connected to the column-directional wire 5 serves as the resistor element 2. In other words, the electron-emitting device of this embodiment includes a device electrode 9 connected to the row-directional wire 4, a conductive film 10, and the resistor element 2. The row-directional wire 4 and the column-directional wire 5 are connected to individual driving circuits (not shown). Appropriate operating voltage is applied to the conductive film 10 via the device electrode 9 and the resistor element 2, so that electrons are emitted from an electron emitting portion 8.

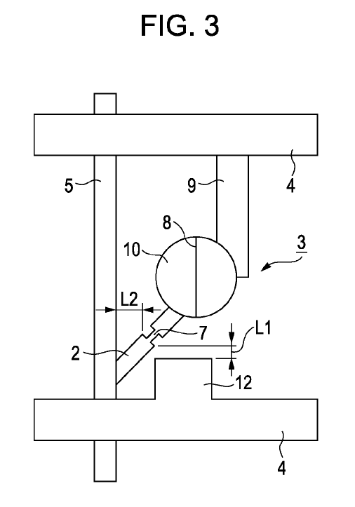

According to the embodiment of the invention, the resistor element 2 has a local fuse portion 7 that is easier to fuse than the other portion. The fuse portion 7 acts to interrupt electrical current flowing between the electron-emitting device and the column-directional wire 5 by fusing with higher priority than the other portion during discharge. Therefore, it is preferable that the fuse portion 7 be a current-concentration portion into which electrical current is to be concentrated and, more specifically, a bent portion, a portion that has a smaller cross-sectional area than the other portion to provide high resistance, or a portion that is made of a material of higher resistance than the other portion to provide high resistance. FIG. 1 shows a configuration example in which the resistor element 2 is bent to form the fuse portion 7. FIG. 3 shows a configuration example in which the width of the fuse portion 7 is decreased so that the cross-sectional area thereof is made smaller than that of the other portion.

As shown in FIG. 8, the invention also includes a configuration in which a pair of device electrodes 9 and 9′ are provided, and the resistor element 2 is formed at part of the device electrode 9′ connected to the column-directional wire 5.

Furthermore, in the embodiment of the invention, the fuse portion 7 is disposed closer to the row-directional wire 4 than to the column-directional wire 5 (L1<L2). If high current flows through the electron-emitting device due to discharge, the fuse portion 7 is fused, and the constituent materials of the fuse portion 7 are gasified to cause the second discharge. However, providing the fuse portion 7 close to the low-resistance row-directional wire 4, as in the embodiment of the invention, the second discharge is led to the row-directional wire 4. This prevents the discharge current flowing to the column-directional wire 5, thereby preventing the surrounding electron-emitting devices from being broken due to the high discharge current flowing through the column-directional wire 5, as in the related art.

In the invention, the row-directional wire 4 may have a current absorbing portion 12 protruding toward the fuse portion 7, as shown in FIG. 3, to bring the fuse portion 7 close to the row-directional wire 4. This providing the current absorbing portion 12 allows the fuse portion 7 of the resistor element 2 to be disposed closer to the row-directional wire 4 than to the column-directional wire 5 even if the fuse portion 7 is disposed in an appropriate location, that is, allows easy layout of the components of the electron-emitting device. It is preferable that the current absorbing portion 12 be a low-resistance member so that the resistance thereof combined with the resistance of the row-directional wire 4 is lower than the resistance of the column-directional wire 5.

It is preferable that the row-directional wire 4 including the current absorbing portion 12 except at least part around the resistor element 2 be covered with an insulator to reduce the exposed area of the low-resistance member and decrease discharge frequency.

Furthermore, it is preferable that the entire column-directional wire 5 is covered with an insulator to reduce discharge frequency and to force the discharge to shift to the row-directional wire 4.

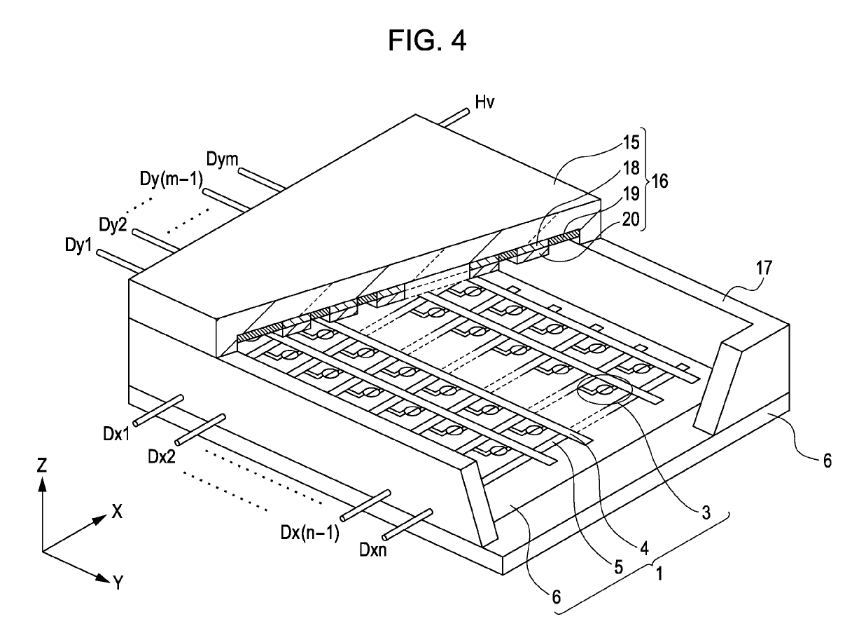

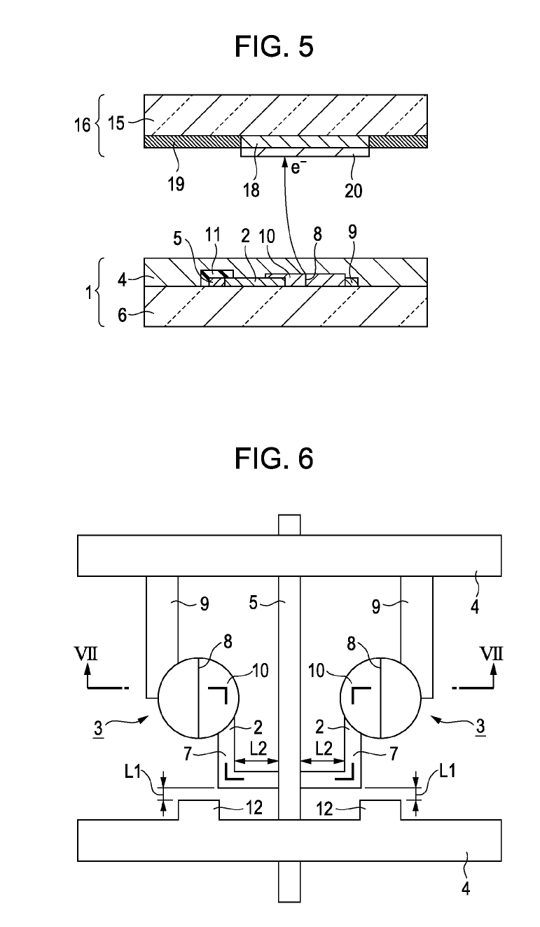

Next, an image display apparatus incorporating the above-described electron source substrate will be specifically described by way of example. FIG. 4 is a perspective view of a display panel of the image display apparatus incorporating the electron source substrate in FIG. 1, with part of the panel broken away to show the internal configuration thereof. FIG. 5 is a schematic cross-sectional view of one of the pixels of the display panel shown in FIG. 4, taken in the X-direction.

In FIG. 4, the electron source substrate 1 and a light-emitting substrate 16 are hermetically joined together with a side wall 17 to form an envelope (airtight chamber) to maintain the interior under vacuum.

The electron source substrate 1 is configured such that the electron-emitting devices 3 are arranged in an m x n matrix form between the row-directional wires 4 and the column-directional wires 5 on a substrate 6.

The light-emitting substrate 16 is configured such that fluorescent layers 18 comprised of the three primary colors, red (R), green (G), and blue (B), the colors divided into individual pixels by a black matrix (BM) 19, are formed on a substrate 15, and that a metal back (MB) 20 is formed on the surface of each fluorescent layer 18.

External terminals Dy1 to Dym and Dx1 to Dxn and a high-voltage terminal Hv are airtight connecting terminals provided to electrically connect the display panel with the driving circuits, to be described below. The external terminals Dy1 to Dym are electrically connected to the individual row-directional wires 4. The external terminals Dx1 to Dxn are electrically connected to the individual column-directional wires 5. The high-voltage terminal Hv is electrically connected to the anode electrodes (BM 19 and MB 20).

In the image display apparatus described above, when operating voltage is applied to the electron-emitting devices on the electron source substrate 1 through the external terminals Dy1 to Dym and Dx1 to Dxn, electrons are emitted from the electron-emitting devices 3. At the same time, a high voltage from several hundred volts to several tens kilovolts is applied to the anode electrodes through the high-voltage terminal Hv to accelerate the emitted electrons, thereby causing the electron beams to collide with the fluorescent layers 18 that constitute the pixels on the light-emitting substrate 16. Thus, the fluorescent members of R, G, and B are excited to emit light, thus forming a color image.

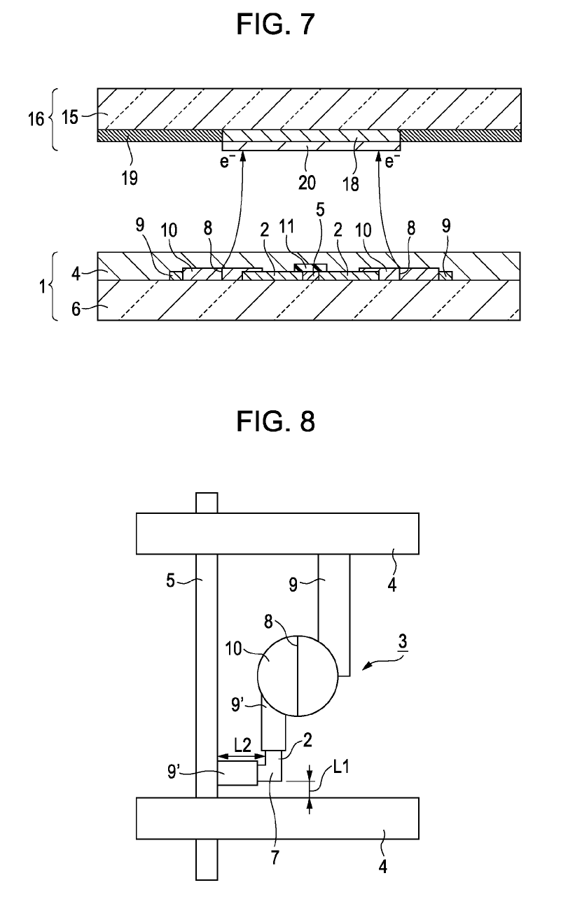

Furthermore, in the invention, a configuration in which electrons are emitted to one pixel from two or more electron-emitting devices, as shown in FIGS. 6 and 7, is preferable. FIG. 6 is a schematic plan view thereof, and FIG. 7 is a schematic cross-sectional view taken along line VII-VII in FIG. 6. This configuration is preferable because no pixel defect occurs even if one of the electron-emitting devices is broken due to discharge, and thus, no defect is detected in the image on the display.

### EXAMPLES

The invention will be described in detail below using concrete examples.

### Example 1

This is an example of the electron source substrate with the configuration shown in FIG. 1.

First, the device electrodes 9 that are part of the electron-emitting devices 3 were formed in a matrix form on the glass substrate 6. The device electrodes 9 were formed in such a manner that a titanium film with a thickness of 5 nm was formed as an undercoating layer by sputtering, on which a platinum film with a thickness of 40 nm was formed by sputtering, and they were subjected to patterning by photolithography.

Next, as the resistor element 2, tantalum oxide or tantalum nitride was formed by sputtering into a shape having the bent portion (fuse portion 7) into which an electrical current is to be concentrated. The resistance of the thus-formed resistor element 2 was about 3 kΩ.

Next, silver photo paste was screen-printed and dried, and was thereafter exposed to light for development to form the column-directional wires 5 in a predetermined linear pattern. The column-directional wires 5 after burning were set to about 10 μm in thickness and 20 μm in width. The resistance of each column-directional wire 5 after burning was about 100Ω.

Next, PbO-based photosensitive glass paste was screen-printed on the column-directional wires 5, was thereafter exposed to light for development, and was finally burned at a temperature around 480° C. to form an insulating layer 11. The insulating layer 11 was formed so as to cover the intersections of the row-directional wires 4, to be described later, and the column-directional wires 5 and to allow the electrical connection between the row-directional wires 4 and the device electrodes 9. The insulating layer 11 was set to about 30 μm in thickness and about 150 μm in width.

Next, the row-directional wires 4 were formed on the insulating layer 11 in the direction perpendicular to the column-directional wires 5. The row-directional wires 4 were formed in such a manner that silver paste was screen-printed using a patterned printing plate, is dried, and is then burned at around 480° C. The thickness of the row-directional wires 4 was set at about 15 μm. The resistance of each of the thus-formed row-directional wires 4 was about 4Ω.

In the thus-formed electron source substrate 1, the shortest distance (L1) between the fuse portion 7 and the row-directional wire 4 was about 10 μm, and the shortest distance (L2) between the fuse portion 7 and the column-directional wire 5 was about 40 μm. The fuse portion 7 was disposed closer to the row-directional wire 4.

After the substrate 6 having the matrix wires was sufficiently cleaned, the conductive films 10, which are part of the electron-emitting devices 3, were individually formed between the device electrodes 9 and the resistor elements 2 by jetting ink. In this example, a palladium monoxide (PdO) film with a dot diameter of about 60 μm and a thickness of 10 nm at the maximum was used as the conductive film 10.

Next, in this process called forming, electrical power was applied to the conductive films 10 between the device electrodes 9 and the resistor elements 2 to crack the conductive films 10, thereby forming the electron emitting portions 8 having high electrical resistance. The resistance of the conductive film 10 thus acquired was from 10²Ω to 10⁷Ω.

The electron source substrate 1 including the plurality of electron-emitting devices 3 was formed by the foregoing processes.

An image display apparatus incorporating the thus-formed electron source substrate 1, with a configuration shown in FIG. 5, was produced.

In the thus-produced image display apparatus, excessive voltage was applied to the electron-emitting devices 3 to induce discharge, discharge current through the row-directional wires 4 was detected, and little discharge current through the column-directional wires 5 was detected. After the discharge is induced, the characteristics of electron-emitting devices 3 other than the electron-emitting devices 3 into which the electric discharge was induced was measured. The measurement did not differ much from that before induced discharge. An analysis of the electron-emitting devices 3 showed that the resistor elements 2 that are part of the electron-emitting devices 3 into which the discharge was induced had fused portions around the fuse portions 7, but the resistor elements 2 connected to the other electron-emitting devices 3 had no fused portion. That is, the analysis showed that the electron-emitting devices 3 other than the electron-emitting devices 3 into which discharge was induced were not affected.

### Example 2

This is an example of the electron source substrate with the configuration shown in FIG. 3.

This example is the same as Example 1 except that the fuse portion 7 of the resistor element 2 in Example 1 is decreased in cross-sectional area and that the row-directional wire 4 has the current absorbing portion 12 projecting therefrom toward the resistor element 2. The shortest distance (L1) between the fuse portion 7 and the current absorbing portion 12 was about 10 μm, and the shortest distance (L2) between the fuse portion 7 and the column-directional wire 5 was about 30 μm. The fuse portion 7 was disposed closer to the current absorbing portion 12 that is part of the row-directional wire 4.

The current absorbing portion 12 was formed in the same layer and from the same material as the row-directional wire 4 by screen-printing using a printing plate in a changed shape.

An image display apparatus incorporating the thus-formed electron source substrate was produced by the same method as in Example 1 and was analyzed as in Example 1. The analysis showed that electron-emitting devices 3 other than electron-emitting devices 3 into which discharge was induced and the driving circuits were not affected, as in Example 1.

### Example 3

This example is the same as Example 2 except that the row-directional wire 4 except part of the current absorbing portion 12 in Example 2 and the column-directional wire 5 are covered with an insulator throughout. Therefore, distance L1 is 10 μm, while distance L2, that is, the creepage distance between the fuse portion 7 and the column-directional wire 5 is theoretically infinite because the column-directional wire 5 is covered with the insulator.

The insulator that covers the row-directional wire 4 and the column-directional wire 5 was formed by the same method as for the insulating layer 11 in Example 1.

An image display apparatus incorporating the thus-formed electron source substrate was produced by the same method as in Example 1 and was analyzed as in Example 1. The analysis showed that electron-emitting devices 3 other than electron-emitting devices 3 into which discharge was induced and the driving circuits were not affected, as in Example 1.

### Example 4

This is an example of the electron source substrate with the configuration shown in FIGS. 6 and 7.

This example is the same as Example 1 except that two electron-emitting devices 3 are disposed, with one column-directional wire 5 interposed therebetween, and that the row-directional wire 4 has the current absorbing portions 12 projecting therefrom toward the fuse portions 7.

The shortest distance (L1) between the fuse portions 7 and the current absorbing portions 12 was about 10 μm, and the shortest distance (L2) between the fuse portions 7 and the column-directional wire 5 was about 20 μm. The fuse portions 7 were disposed closer to the current absorbing portions 12 that are part of the row-directional wire 4.

The width of one electron-emitting device 3 was set to about half of that in Example 1 to form the two electron-emitting devices 3 in the same area as in Example 1. Therefore, the resistance of the resistor elements 2 was about 2 kΩ.

An image display apparatus incorporating the thus-formed electron source substrate was produced by the same method as in Example 1. In this example, the light-emitting substrate 16 was formed so that one fluorescent layer 18 corresponds to the two electron-emitting devices 3 that are disposed, with the column-directional wire 5 interposed therebetween.

In this example, the image display apparatus was connected to an exhaust system, and discharge was induced by reducing the degree of vacuum. When the image display apparatus was activated after the discharge, and discharge portions were observed with a loupe, only pixels at the discharge portions appeared slightly darker than the other pixels. However, when the image display apparatus was visually observed from a distance therefrom so that the entire screen comes in sight, no dark portions could be detected as image defects.

### Example 5

This is an example of the electron source substrate with the configuration shown in FIG. 8.

This example is the same as Example 1 except that the resistor element 2 was formed as part of the device electrode 9′. In this example, the shortest distance (L1) between the fuse portion 7 and the row-directional wire 4 was about 10 μm, and the shortest distance (L2) between the fuse portion 7 and the column-directional wire 5 was about 40 μm. The fuse portion 7 was disposed closer to the row-directional wire 4.

In this example, the device electrode 9′ and the resistor element 2 were formed in desired shapes by using a printing plate (screen printing plate) in a shape different from that in Example 1, and the device electrode 9′ was formed at the same time the device electrode 9 was formed. The resistance of the resistor element 2 was about 1.5 kΩ.

An image display apparatus incorporating the thus-formed electron source substrate was produced by the same method as in Example 1 and was analyzed as in Example 1. The analysis showed that electron-emitting devices 3 other than electron-emitting devices 3 into which discharge was induced and the driving circuits were not affected, as in Example 1.

While the invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-315444 filed Dec. 11, 2008, which is hereby incorporated by reference herein in its entirety.

What is claimed is:

1. An electron source substrate comprising:
a substrate;
a row-directional wire disposed on the substrate;
a column-directional wire disposed on the substrate;
an electron-emitting device a first end of which is connected to the row-directional wire and a second end of which is connected to the column-directional wire via a resistor element, and to which operating voltage is applied through the row-directional wire and the column-directional wire,
wherein the resistance of the row-directional wire is lower than the resistance of the column-directional wire; and
wherein the resistor element includes a local fuse portion that is easier to fuse than the other portion, the fuse portion being disposed closer to the row-directional wire than to the column-directional wire.

2. The electron source substrate according to claim 1, wherein the fuse portion is a current-concentration portion into which electrical current is to be concentrated.

3. The electron source substrate according to claim 2, wherein the current-concentration portion is a bent portion.

4. The electron source substrate according to claim 2, wherein the current-concentration portion is smaller in cross-sectional area than the other portion.

5. The electron source substrate according to claim 1, wherein part of the row-directional wire has a current absorbing portion protruding toward the fuse portion.

6. The electron source substrate according to claim 1, wherein the row-directional wire is covered with an insulator.

7. The electron source substrate according to claim 1, wherein the column-directional wire is covered with an insulator.

8. An image display apparatus comprising:
an electron source substrate including a plurality of electron-emitting devices and wires through which voltage is applied to the electron-emitting devices; and
a light-emitting substrate including a fluorescent layer that emits light by irradiation with electrons emitted from the electron-emitting devices,
wherein the electron source substrate is the electron source substrate according to claim 1.

9. The image display apparatus according to claim 8, wherein electrons are emitted to one pixel from two or more electron-emitting devices.
